(19) United States
(12) Patent Application Publication
(10) Pub. No.: US 2013/0247541 A1
(43) Pub. Date: Sep. 26, 2013

(54) GAS TURBINE INTAKE ANTI-ICING DEVICE

(71) Applicant: MITSUI ENGINEERING & SHIPBUILDING CO., LTD., (US)

(72) Inventors: Fusao KUSUNOKI, Tamano-shi (JP); Kiyomasa YAHATA, Tamano-shi (JP); Shunsuke NISHIE, Tamano-shi (JP)

(73) Assignee: MITSUI ENGINEERING & SHIPBUILDING CO., LTD., Tokyo (JP)

(21) Appl. No.: 13/709,680

(22) Filed: Dec. 10, 2012

(30) Foreign Application Priority Data
Mar. 21, 2012 (JP) 2012-063073

(51) Int. Cl. F02C 7/047

(52) U.S. Cl. CPC F02C 7/047
USPC 60/39.093

(57) ABSTRACT

The gas turbine intake anti-icing device is used for a gas turbine electric power generation system (1) having a gas turbine (2) and a power generator (20) coupled to the gas turbine (2) and rotationally driven to generate electrical power. The gas turbine intake anti-icing device includes a power generator cooling mechanism (21, 22, 23, 25), which takes air from the outside and introduces air into the power generator (20) to cool the power generator (20), and exhaust air supply path (31) that connects intake path (9) of the gas turbine (2) to exhaust path (30) for air that is discharged from power generator cooling mechanism (21, 22, 23, 25) after the power generator (20) is cooled. The air discharged from the power generator cooling mechanism (21, 22, 23, 25) is supplied to the intake path (9) of the gas turbine (2) through the exhaust air supply path (31).

### BACKGROUND OF THE INVENTION

1. Field of the Invention

The present invention relates to a gas turbine intake anti-icing device that prevents the vicinity of a gas turbine intake port from icing.

2. Description of the Related Art

A gas turbine electric power generation system having a gas turbine and a power generator has been widely used. The power generator is coupled to the gas turbine through a transmission or the like and rotationally driven to generate electrical power.

Under specific atmospheric conditions such as low-temperature, high-humidity atmospheric conditions, however, icicles may be formed near the gas turbine intake port to narrow the intake port and decrease intake efficiency. Further, the icicles may fall and become sucked into a compressor of the gas turbine to cause a flame out trip of the gas turbine or damage of compressor blades and vanes.

A technology disclosed, for instance, in JP-A-06-33795 (FIGS. 1-2) prevents the vicinity of the gas turbine intake port from icing by extracting high-temperature air compressed by the compressor of the gas turbine and injecting the extracted high-temperature compressed air into the vicinity of the gas turbine intake port. This technology, which extracts the high-temperature air compressed by the compressor and guides the extracted high-temperature compressed air to stator vanes near an engine intake port, is widely used, for instance, for airplane jet engines.

Another technology disclosed, for instance, in JP-A-2000-227030 (FIG. 1) prevents the vicinity of the gas turbine intake port from icing by disposing a heat exchanger in a gas turbine intake path and introducing a high-temperature exhaust gas, which is discharged from the gas turbine, into the heat exchanger to raise the intake air temperature of the gas turbine.

### SUMMARY OF THE INVENTION

As described above, the first related art method prevents the vicinity of the gas turbine intake port from icing by extracting high-temperature air compressed by the compressor of the gas turbine and injecting the extracted high-temperature compressed air into the vicinity of the gas turbine intake port. Further, the second related art method prevents the vicinity of the gas turbine intake port from icing by disposing the heat exchanger in the gas turbine intake path and introducing the high-temperature exhaust gas, which is discharged from the gas turbine, into the heat exchanger to raise the intake air temperature of the gas turbine.

However, the first related art method, which extracts high-temperature air compressed by the compressor of the gas turbine and injects the extracted high-temperature compressed air into the vicinity of the gas turbine intake port, circulates the air compressed by the gas turbine back to the intake side. Therefore, the first related art method is at a disadvantage in that it decreases the efficiency of the gas turbine.

Meanwhile, the second related art method, which disposes the heat exchanger in the gas turbine intake path and introduces the high-temperature exhaust gas, which is discharged from the gas turbine, into the heat exchanger to raise the intake air temperature of the gas turbine, requires that the heat exchanger and a gas circulation path for introducing the exhaust gas into the heat exchanger be disposed. Therefore, the second related art method is also at a disadvantage in that it increases the cost of equipment and makes it necessary to perform maintenance, for instance, on the heat exchanger, which uses the exhaust gas.

The present invention has been made in view of the above circumstances. An object of the present invention is to provide a gas turbine intake anti-icing device that is capable of certainly preventing the vicinity of an intake port of a gas turbine from icing without significantly sacrificing the efficiency of the gas turbine and without increasing the cost of equipment and maintenance.

In accomplishing the above object, according to an aspect of the present invention, there is provided a gas turbine intake anti-icing device used for a gas turbine electric power generation system having a gas turbine and a power generator that is coupled to the gas turbine and rotationally driven to generate electrical power. The gas turbine intake anti-icing device includes a power generator cooling mechanism and an exhaust air supply path. The power generator cooling mechanism takes in air from the outside and introduces the air into the power generator to cool the power generator. The exhaust air supply path connects an intake path of the gas turbine to an exhaust path for air that is discharged from the power generator cooling mechanism after power generator cooling. The air discharged from the power generator cooling mechanism is supplied to the intake path of the gas turbine through the exhaust air supply path.

As described above, the gas turbine intake anti-icing device according to the present invention operates so that high-temperature air discharged from the power generator cooling mechanism after power generator cooling is supplied to the intake path of the gas turbine through the exhaust air supply path. This makes it possible to certainly prevent the vicinity of the intake port of the gas turbine from icing. In addition, the air discharged from the power generator cooling mechanism, which is disposed separately from the gas turbine, is supplied to the intake path of the gas turbine. Therefore, the efficiency of the gas turbine does not decrease due to the conventional extraction of compressed air.

Further, the gas turbine intake anti-icing device according to the present invention is configured so that the exhaust air supply path is disposed to connect the intake path of the gas turbine to the exhaust path for air that is discharged from the power generator cooling mechanism after power generator cooling. Therefore, the cost of equipment does not significantly increase. In addition, maintenance load is minimized.

The gas turbine intake anti-icing device is preferably configured so that the exhaust air supply path is connected to the intake path nearest a gas turbine inlet. When the exhaust air supply path is connected to the intake path nearest the gas turbine inlet, the high-temperature air discharged from the power generator cooling mechanism can be efficiently supplied to the intake port of the gas turbine without lowering the temperature of the high-temperature air. This makes it possible to prevent the vicinity of the intake port of the gas turbine from icing with increased certainty.

Alternatively, the gas turbine intake anti-icing device is preferably configured so that the gas turbine includes an intake air filter, which is disposed in the intake path to purify intake air, and that the exhaust air supply path is connected to an upstream end of the intake air filter. When the exhaust air supply path is connected to the upstream end of the intake air filter, the air used to cool the power generator can be purified. This makes it possible to certainly prevent performance degradation due to dirt on gas turbine blades and vanes.

The gas turbine intake anti-icing device is preferably configured so that a flow regulating mechanism is disposed in the exhaust path and in the exhaust air supply path to adjust the flow rate of air supplied from the power generator cooling mechanism to the gas turbine. When the flow regulating mechanism is disposed in the exhaust path and in the exhaust air supply path to adjust the flow rate of air supplied from the power generator cooling mechanism to the gas turbine, a required amount of high-temperature air can be supplied to the intake port of the gas turbine at required timing.

The gas turbine intake anti-icing device is preferably configured so that the flow regulating mechanism includes a first damper and a second damper. The first damper is disposed in the exhaust path to open and close the exhaust path. The second damper is disposed in the exhaust air supply path to open and close the exhaust air supply path. When the flow regulating mechanism has a simple configuration that includes the first and second damper as described above, the cost of equipment is further reduced and maintenance load is minimized.

The gas turbine intake anti-icing device is preferably configured so that the power generator cooling mechanism includes a cooling fan for introducing air into the power generator and discharging the air into the exhaust path. When the power generator cooling mechanism includes the cooling fan for introducing air into the power generator and discharging the air into the exhaust path, the power generator can be smoothly cooled. In addition, the high-temperature air discharged from the power generator cooling mechanism can be sufficiently supplied to the intake port of the gas turbine.

Further, the gas turbine intake anti-icing device is preferably configured so that the cooling fan is mounted on a rotor of the power generator and rotationally driven by the torque of the rotor. When the cooling fan is mounted on the rotor of the power generator and rotationally driven by the torque of the rotor, the cooling fan can be rotated by strong torque. In addition, the cooling fan does not require any other energy source, such as electrical power, and has a simple structure.

The gas turbine intake anti-icing device preferably includes a gas turbine intake air temperature sensor, which is disposed in the intake path nearest the gas turbine to detect the intake air temperature of the gas turbine, and a controller, which controls the operation of the flow regulating mechanism in accordance with the intake air temperature detected by the gas turbine intake air temperature sensor. When the intake air temperature is not higher than a preselected temperature, the controller preferably operates the flow regulating mechanism so that the air discharged from the power generator cooling mechanism is supplied to the intake path of the gas turbine through the exhaust air supply path. When the controller controls the operation of the flow regulating mechanism in accordance with the intake air temperature detected by the gas turbine intake air temperature sensor as described above, the gas turbine intake anti-icing device can be automatically controlled to prevent the vicinity of the intake port of the gas turbine from icing with increased certainty.

The gas turbine intake anti-icing device preferably further includes a power generator exhaust air temperature sensor, which is disposed in the exhaust air supply path to detect the exhaust temperature of the air discharged from the power generator cooling mechanism. When the exhaust air temperature is higher than the intake air temperature, the controller preferably operates the flow regulating mechanism so that the air discharged from the power generator cooling mechanism is supplied to the intake path of the gas turbine through the exhaust air supply path.

As described above, when the exhaust air temperature is higher than the intake air temperature, the controller operates the flow regulating mechanism so that the air discharged from the power generator cooling mechanism is supplied to the intake path of the gas turbine through the exhaust air supply path. Therefore, air having a higher temperature than the intake air temperature can be supplied to the intake path of the gas turbine automatically with increased certainty.

As described in detail above, the gas turbine intake anti-icing device according to the present invention is used for a gas turbine electric power generation system having a gas turbine and a power generator that is coupled to the gas turbine and rotationally driven to generate electrical power. The gas turbine intake anti-icing device includes a power generator cooling mechanism and an exhaust air supply path. The power generator cooling mechanism takes in air from the outside and introduces the air into the power generator to cool the power generator. The exhaust air supply path connects an intake path of the gas turbine to an exhaust path for air that is discharged from the power generator cooling mechanism after power generator cooling. The air discharged from the power generator cooling mechanism is supplied to the intake path of the gas turbine through the exhaust air supply path. Consequently, the gas turbine intake anti-icing device is at an advantage in that it certainly prevents the vicinity of the intake port of the gas turbine from icing without sacrificing the efficiency of the gas turbine and without increasing the cost and load of equipment and maintenance.

### BRIEF DESCRIPTION OF THE DRAWINGS

FIG. 1 is a schematic diagram illustrating a first embodiment of a gas turbine intake anti-icing device according to the present invention.

FIG. 2 is a schematic diagram illustrating various sensors of the gas turbine intake anti-icing device shown in FIG. 1.

FIG. 3 is a block diagram illustrating an automatic control configuration of the gas turbine intake anti-icing device shown in FIG. 2.

FIG. 4 is a flowchart illustrating how automatic control is exercised by the gas turbine intake anti-icing device shown in FIG. 1.

FIG. 5 is a schematic diagram illustrating a second embodiment of the gas turbine intake anti-icing device according to the present invention.

FIG. 6 is a schematic diagram illustrating various sensors of the gas turbine intake anti-icing device shown in FIG. 5.

FIG. 7 is a block diagram illustrating an automatic control configuration of the gas turbine intake anti-icing device shown in FIG. 6.

### DESCRIPTION OF THE PREFERRED EMBODIMENTS

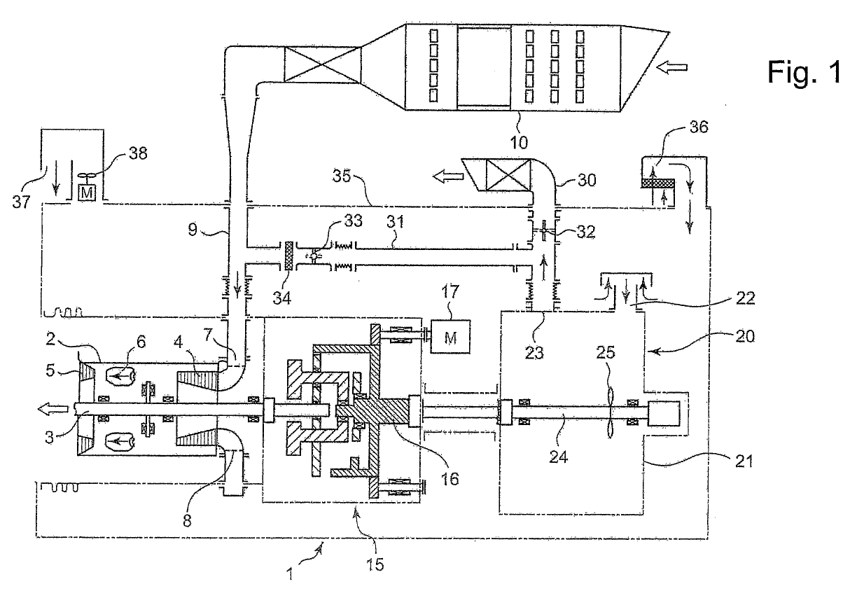

A first embodiment of a gas turbine intake anti-icing device according to the present invention will now be described in detail with reference to FIG. 1 to FIG. 4.

Referring to FIG. 1, the reference numeral 1 denotes a gas turbine electric power generation system. The gas turbine electric power generation system includes a gas turbine 2, a speed reducer 15, and a power generator 20. The speed reducer 15 is coupled to a rotation shaft 3 of the gas turbine 2 to reduce the speed of rotation. The power generator 20 is coupled to a rotation shaft 16 of the speed reducer 15 and rotationally driven to generate electrical power.

The gas turbine 2 is configured so that a compressor 4 is coupled to a turbine 5 by the rotation shaft 3. A combustor 6 is disposed between the compressor 4 and the turbine 5. An intake port (inlet) 7 of the compressor 4 is provided with a wire gauze 8 that prevents the entry of foreign matter from the outside.

When a conventional gas turbine is used under specific atmospheric conditions such as low-temperature, high-humidity atmospheric conditions, an icicle may be formed on the wall surface of the intake port of the gas turbine or the wire gauze of the intake port. As a result, the intake port may be substantially narrowed to decrease intake efficiency. Further, the icicle may fall and become sucked into the compressor of the gas turbine to cause a flame out trip of the gas turbine or damage of compressor blades and vanes.

An intake air filter 10 is disposed in an intake path 9 of the gas turbine 2 to purify intake air. The intake air filter 10 purifies the intake air to prevent performance degradation due to dirt on gas turbine blades and vanes. Further, the intake air filter 10 includes an intake cooler (not shown) to ensure that air is taken in at an optimum temperature even when atmospheric air temperature is high. The aforementioned speed reducer 15 is provided with a starter motor 17, which is used to start the gas turbine 2.

A casing 21 of the power generator 20 has an air inlet 22 and an air outlet 23 so that external air for cooling the power generator 20 can be taken into the casing 21. Further, a cooling fan 25 is mounted on a rotor 24 of the power generator 20. The cooling fan 25 forces air into the casing 21 of the power generator 20 to cool a heated winding of the power generator 20 and discharge the air, which is heated when used to cool the winding, from the air outlet 23. The casing 21, the air inlet 22, the air outlet 23, and the cooling fan 25 form a power generator cooling mechanism.

An exhaust path 30 is extended from the air outlet 23 provided for the casing 21 of the power generator 20 so that the air used to cool the power generator 20 is discharged from the air outlet 23 into the atmosphere. An exhaust air supply path 31 is branched off from the exhaust path 30 to connect the exhaust path 30 to the intake path 9 of the gas turbine 2.

A first damper (flow regulating mechanism) 32, which opens and closes the exhaust path 30, is disposed in the exhaust path 30 downstream of a portion from which the exhaust air supply path 31 is branched off. A second damper (flow regulating mechanism) 33 is disposed in the exhaust air supply path 31 to open and close the exhaust air supply path 31. A wire gauze filter 34 is disposed downstream of the second damper 33 in the exhaust air supply path 31 to prevent the entry of foreign matter into the gas turbine 2.

When the first damper 32 opens and the second damper 33 closes, the air heated when used to cool the winding of the power generator 20 is discharged from the exhaust path 30 into the atmosphere. When, on the other hand, the first damper 32 closes and the second damper 33 opens, the air heated when used to cool the winding of the power generator 20 is delivered to the intake path 9 of the gas turbine 2 through the exhaust air supply path 31 and introduced into the intake port 7 of the gas turbine 2.

The flow regulating mechanisms need not always be formed by dampers that are open/close valves. Alternatively, the flow regulating mechanisms may be formed by flow regulating valves, one or both of which are capable of arbitrarily adjusting a flow rate.

The speed reducer 15, the power generator 20, and the exhaust air supply path 31, for example, are surrounded by an enclosure 35. The enclosure 35 is provided with an air inlet 36 and an air outlet 37. An electric fan 38 is disposed near the air outlet 37 to smoothly discharge air. The enclosure 35 reduces the level of noise emitted from various devices, protects various devices against rain and wind, and serves as the path of cooling air.

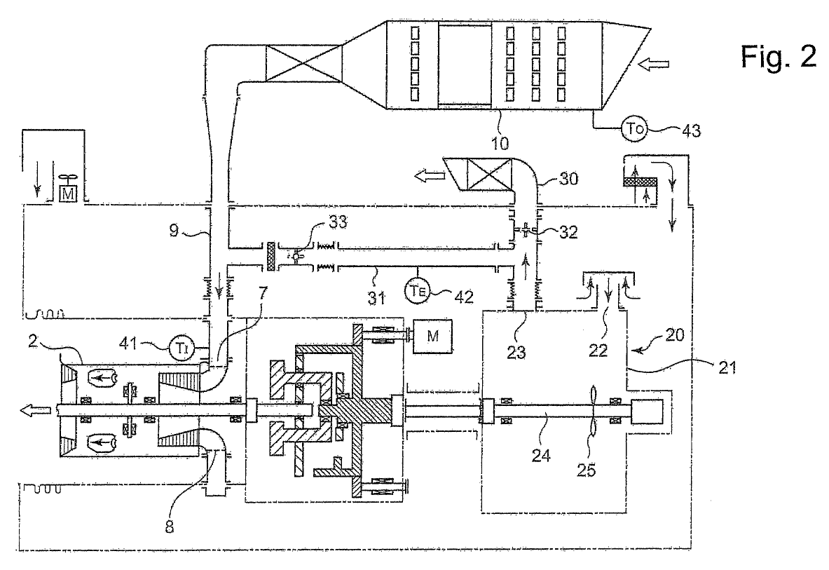

For the gas turbine intake anti-icing device, switching between the first damper 32 and the second damper 33 can be manually made. However, when the following configuration is employed while the first damper 32 and the second damper 33 are of an electrically driven type, the gas turbine intake anti-icing device can be automatically controlled. An example of automatic control will now be described with reference to FIG. 2 to FIG. 4. Like elements in FIG. 1 to FIG. 4 are designated by the same reference numerals.

As shown in FIG. 2, a gas turbine intake air temperature sensor 41 for detecting the intake air temperature TI of the gas turbine 2 is disposed in the intake path 9 nearest the intake port 7 of the gas turbine 2. A power generator exhaust air temperature sensor 42 for detecting the exhaust temperature TE of the air discharged from the power generator 20 is disposed in the exhaust air supply path 31. An atmospheric air temperature sensor 43 for detecting an atmospheric air temperature TO is disposed in the intake path 9. Particularly, for the gas turbine intake anti-icing device according to the present embodiment, which includes the intake air filter 10, the atmospheric air temperature sensor 43 is disposed at the inlet of the intake air filter 10.

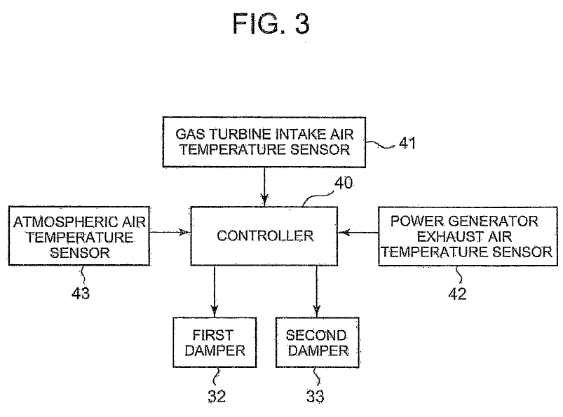

A controller 40 for controlling the operations of the first and second dampers 32, 33, which are of an electrically driven type, is disposed as shown in FIG. 3 and electrically connected to the first damper 32, the second damper 33, the gas turbine intake air temperature sensor 41, the power generator exhaust air temperature sensor 42, and the atmospheric air temperature sensor 43.

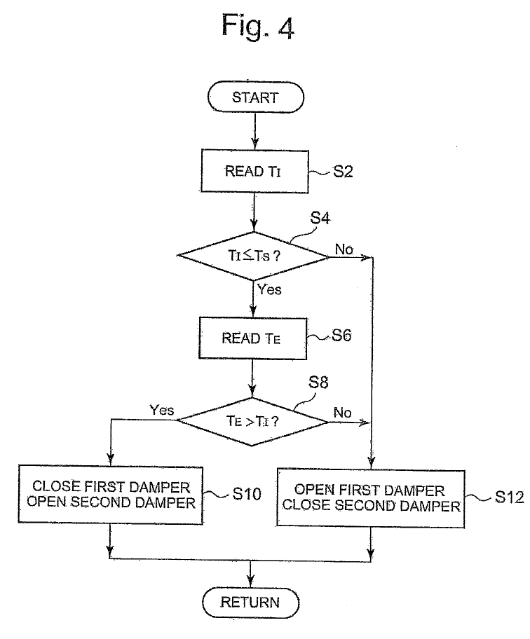

As shown in FIG. 4, the controller 40 reads the intake air temperature TI of the gas turbine 2, which is detected by the gas turbine intake air temperature sensor 41 (step S2). Next, the controller 40 judges whether the intake air temperature TI is not higher than a preselected temperature TS (step S4). The preselected temperature TS is a temperature at which no icing occurs at the intake port 7 of the gas turbine 2.

If the judgment result obtained in step S4 is negative (if the query in step S4 is answered “NO”), that is, if icing cannot possibly occur at the intake port 7 of the gas turbine 2, the controller 40 opens the first damper 32 and closes the second damper 33 so that high-temperature air, which is heated when used to cool the winding of the power generator 20, is passed through the first damper 32 and discharged from the exhaust path 30 into the atmosphere.

If, on the other hand, the judgment result obtained in step S4 is affirmative (if the query in step S4 is answered “YES”), that is, if icing can possibly occur at the intake port 7 of the gas turbine 2, the controller 40 reads the exhaust temperature TE of the air discharged from the power generator 20, which is detected by the power generator exhaust air temperature sensor 42 (step S6). The controller 40 then judges whether the exhaust air temperature TE is higher than the intake air temperature TI (step S8).

If the judgment result obtained in step S8 is negative, that is, if the exhaust air temperature TE is not higher than the intake air temperature TI so that the air discharged from the power generator 20 does not raise the intake air temperature TI, the controller 40 opens the first damper 32 and closes the second damper 33. The high-temperature air, which is heated when used to cool the winding of the power generator 20, is then passed through the first damper 32 and discharged from the exhaust path 30 into the atmosphere.

If, on the other hand, the judgment result obtained in step S8 is affirmative, that is, if the exhaust air temperature TE is higher than the intake air temperature TI so that the air discharged from the power generator 20 raises the intake air temperature TI, the controller 40 closes the first damper 32 and opens the second damper 33. The high-temperature air, which is heated when used to cool the winding of the power generator 20, is then supplied from the exhaust air supply path 31 to the intake path 9 of the gas turbine 2. This raises the intake air temperature TI of the gas turbine 2.

In the above instance, the cooling fan 25 not only forces the air into the casing 21 of the power generator 20 to cool the heated winding of the power generator 20, but also forces the air discharged from the power generator 20 into the intake path 9 of the gas turbine 2 through the exhaust air supply path 31.

For example, the amount of such air is approximately one-third the amount of air directly taken in when the gas turbine 2 is operating at 100 percent capacity. Therefore, an adequate amount of high-temperature air can be supplied to the intake port 7 of the gas turbine 2, or more specifically, to the wall surface of the intake port 7 and to the wire gauze of the intake port 7. This ensures that no icing occurs. Subsequently, the controller 40 repeats steps S4 and beyond.

As described above, the gas turbine intake anti-icing device according to the present embodiment operates so that the high-temperature air discharged from the power generator cooling mechanism 21, 22, 23, 25 is supplied to the intake path 9 of the gas turbine 2 through the exhaust air supply path 31. This makes it possible to certainly prevent the vicinity of the intake port 7 of the gas turbine 2 from icing.

Further, as the air discharged from the power generator cooling mechanism 21, 22, 23, 25, which is disposed separately from the gas turbine 2, is supplied to the intake path 9 of the gas turbine 2, the efficiency of the gas turbine does not decrease due to the extraction of compressed air unlike in a conventional gas turbine intake anti-icing device.

Moreover, as the exhaust air supply path 31 is connected particularly to the intake path 9 nearest the intake port 7 of the gas turbine 2, the high-temperature air discharged from the power generator cooling mechanism 21, 22, 23, 25 can be supplied to the intake port 7 of the gas turbine 2 efficiently without lowering its temperature. This makes it possible to certainly prevent the vicinity of the intake port 7 of the gas turbine 2 from icing.

As the flow regulating mechanisms 32, 33 for adjusting the flow rate of air supplied from the power generator cooling mechanism 21, 22, 23, 25 to the gas turbine 2 are disposed in the exhaust path 30 and the exhaust air supply path 31, a required amount of high-temperature air can be supplied to the intake port of the gas turbine at required timing.

Further, as the flow regulating mechanisms 32, 33 are formed by the first damper 32, which is disposed in the exhaust path 30 to open and close the exhaust path 30, and the second damper 33, which is disposed in the exhaust air supply path 31 to open and close the exhaust air supply path 31, the resulting configuration is simple. Therefore, the cost of equipment is low. In addition, maintenance load is minimized.

Furthermore, as the power generator cooling mechanism 21, 22, 23, 25 includes the cooling fan 25, which introduces air into the power generator 20 and discharges the air into the exhaust path 30, the power generator 20 can be smoothly cooled. In addition, the high-temperature air discharged from the power generator cooling mechanism 21, 22, 23, 25 can be sufficiently supplied to the intake port 7 of the gas turbine 2.

Moreover, as the cooling fan 25 is mounted on the rotor 24 of the power generator 20 and rotationally driven by the torque of the rotor 24 of the power generator 20, the cooling fan 25 can be rotated by strong torque. In addition, the cooling fan 25 does not require any other energy source, such as electrical power, and has a simple structure.

Besides, as the controller 40 controls the operations of the flow regulating mechanisms 32, 33 in accordance with the intake air temperature TI detected by the gas turbine intake air temperature sensor 41, the gas turbine intake anti-icing device according to the present embodiment can be automatically controlled. Likewise, as the flow regulating mechanisms 32, 33 operate to supply the air discharged from the power generator cooling mechanism 21, 22, 23, 25 to the intake path 9 of the gas turbine 2 through the exhaust air supply path 31 when the exhaust air temperature TE is higher than the intake air temperature TI, air having a higher temperature than the intake air temperature TI can be supplied to the intake path 9 of the gas turbine 2 automatically with certainty.

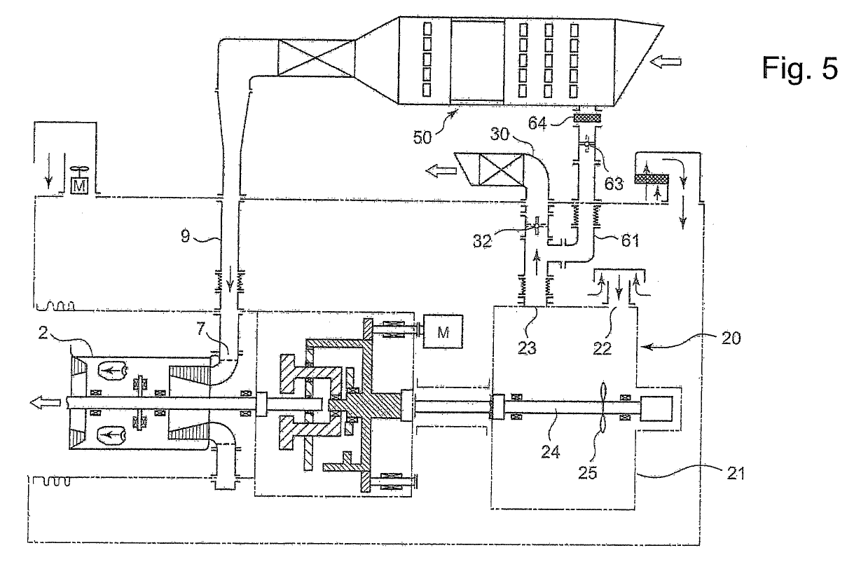

A second embodiment of the gas turbine intake anti-icing device according to the present invention will now be described in detail with reference to FIG. 5 to FIG. 7. Elements identical with those of the first embodiment, which is described earlier, are designated by the same reference numerals as the corresponding elements.

As shown in FIG. 5, an exhaust air supply path 61 is branched off from the exhaust path 30 and used to connect the exhaust path 30 to the inlet (upstream side) of an intake air filter 50, which is disposed in the intake path 9 of the gas turbine 2 to purify intake air. The intake air filter 50 purifies the intake air and prevents performance degradation due to dirt on gas turbine blades and vanes. The intake air filter 50 includes an intake cooler to ensure that air is taken in at an optimum temperature even when the atmospheric air temperature is high.

The first damper (flow regulating mechanism) 32, which opens and closes the exhaust path 30, is disposed in the exhaust path 30 downstream of a portion from which the exhaust air supply path 61 is branched off. A second damper (flow regulating mechanism) 63 is disposed in the exhaust air supply path 61 to open and close the exhaust air supply path 61. A wire gauze filter 64 is disposed downstream of the second damper 63 in the exhaust air supply path 61 to prevent the entry of foreign matter into the gas turbine 2.

When the first damper 32 opens and the second damper 63 closes, the air heated when used to cool the winding of the power generator 20 is discharged from the exhaust path 30 into the atmosphere. When, on the other hand, the first damper 32 closes and the second damper 63 opens, the air heated when used to cool the winding of the power generator 20 is delivered to the inlet of the intake air filter 50 in the intake path 9 of the gas turbine 2 through the exhaust air supply path 61 and introduced into the intake port 7 of the gas turbine 2 through the intake air filter 50.

The flow regulating mechanisms need not always be formed by dampers that are open/close valves. Alternatively, the flow regulating mechanisms may be formed by flow regulating valves, one or both of which are capable of arbitrarily adjusting the flow rate.

For the gas turbine intake anti-icing device, switching between the first damper 32 and the second damper 63 can be manually made. However, when the following configuration is employed while the first damper 32 and the second damper 63 are of an electrically driven type, the gas turbine intake anti-icing device can be automatically controlled.

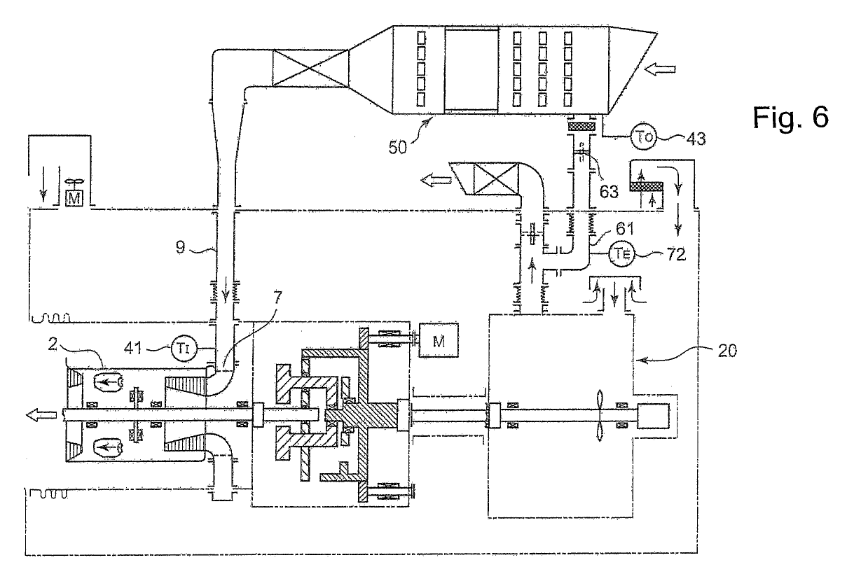

As shown in FIG. 6, the gas turbine intake air temperature sensor 41 for detecting the intake air temperature TI of the gas turbine 2 is disposed in the intake path 9 nearest the intake port 7 of the gas turbine 2. A power generator exhaust air temperature sensor 72 for detecting the exhaust temperature TE of the air discharged from the power generator 20 is disposed in the exhaust air supply path 61. The atmospheric air temperature sensor 43 for detecting the atmospheric air temperature TO is disposed in the intake path 9. Particularly, for the gas turbine intake anti-icing device according to the present embodiment, which includes the intake air filter 50, the atmospheric air temperature sensor 43 is disposed at the inlet of the intake air filter 50 and upstream of a joint between the intake air filter 50 and the exhaust air supply path 61.

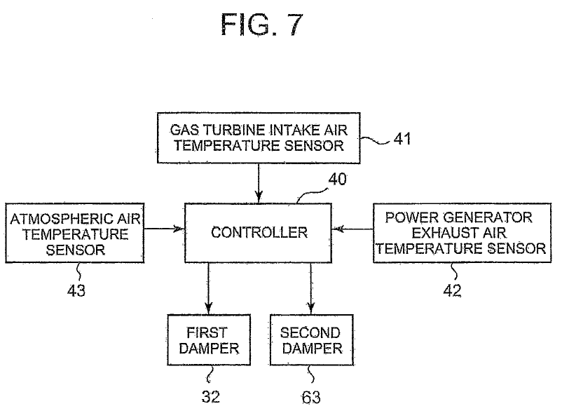

The controller 40 for controlling the operations of the first and second dampers 32, 63, which are of an electrically driven type, is disposed as shown in FIG. 7 and electrically connected to the first damper 32, the second damper 63, the gas turbine intake air temperature sensor 41, a power generator exhaust air temperature sensor 72, and the atmospheric air temperature sensor 43. The control process performed by the controller 40 of the gas turbine intake anti-icing device according to the present embodiment is the same as described with reference to FIG. 4, which depicts the first embodiment, and will not be redundantly described.

As the gas turbine intake anti-icing device according to the present embodiment operates so that the high-temperature air discharged from the power generator cooling mechanism 21, 22, 23, 25 is supplied to the intake path 9 of the gas turbine 2 through the exhaust air supply path 61. This makes it possible to certainly prevent the vicinity of the intake port 7 of the gas turbine 2 from icing.

Further, as the air discharged from the power generator cooling mechanism 21, 22, 23, 25, which is disposed separately from the gas turbine 2, is supplied to the intake path 9 of the gas turbine 2, the efficiency of the gas turbine does not decrease due to the extraction of compressed air unlike in the conventional gas turbine intake anti-icing device.

Furthermore, the gas turbine 2 includes the intake air filter 50 that is disposed in the intake path 9 to purify the intake air, and the exhaust air supply path 61 is connected to the upstream end of the intake air filter 50. Hence, the air used to cool the power generator 20 can be purified. This makes it possible to prevent performance degradation due to dirt on the blades and vanes of the gas turbine 2 with increased certainty.

As the flow regulating mechanisms 32, 63 for adjusting the flow rate of air supplied from the power generator cooling mechanism 21, 22, 23, 25 to the gas turbine 2 are disposed in the exhaust path 30 and the exhaust air supply path 61, a required amount of high-temperature air can be supplied to the intake port of the gas turbine at required timing.

Further, as the flow regulating mechanisms 32, 63 are formed by the first damper 32, which is disposed in the exhaust path 30 to open and close the exhaust path 30, and the second damper 63, which is disposed in the exhaust air supply path 61 to open and close the exhaust air supply path 61, the resulting configuration is simple. Therefore, the cost of equipment is low. In addition, maintenance load is minimized.

Furthermore, as the power generator cooling mechanism 21, 22, 23, 25 includes the cooling fan 25, which introduces air into the power generator 20 and discharges the air into the exhaust path 30, the power generator 20 can be smoothly cooled. In addition, the high-temperature air discharged from the power generator cooling mechanism 21, 22, 23, 25 can be sufficiently supplied to the intake port 7 of the gas turbine 2.

Moreover, as the cooling fan 25 is mounted on the rotor 24 of the power generator 20 and rotationally driven by the torque of the rotor 24 of the power generator 20, the cooling fan 25 can be rotated by strong torque. In addition, the cooling fan 25 does not require any other energy source, such as electrical power, and has a simple structure.

Besides, as the controller 40 controls the operations of the flow regulating mechanisms 32, 63 in accordance with the intake air temperature TI detected by the gas turbine intake air temperature sensor 41, the gas turbine intake anti-icing device according to the present embodiment can be automatically controlled. Likewise, as the flow regulating mechanisms 32, 63 operate to supply the air discharged from the power generator cooling mechanism 21, 22, 23, 25 to the intake path 9 of the gas turbine 2 through the exhaust air supply path 61 when the exhaust air temperature TE is higher than the intake air temperature TI, air having a higher temperature than the intake air temperature TI can be supplied to the intake path 9 of the gas turbine 2 automatically with certainty.

The other features of the gas turbine intake anti-icing device according to the present embodiment will not be described because they are the same as those of the gas turbine intake anti-icing device according to the first embodiment.

The gas turbine intake anti-icing device according to the present invention is not only applicable to a gas turbine electric power generation system, but also applicable to various other gas turbine systems.

### FIG. 3

41 . . . Gas Turbine Intake Temperature Sensor
43 . . . Atmospheric Temperature Sensor
40 . . . Controller
42 . . . Power Generator Exhaust Temperature Sensor
32 . . . First Damper
33 . . . Second Damper

### FIG. 4

Start
S2 . . . Read TI
S6 . . . Read TE
S10 . . . Close First Damper and Open Second Damper
S12 . . . Open First Damper and Close Second Damper
Return

### FIG. 7

41 . . . Gas Turbine Intake Temperature Sensor
43 . . . Atmospheric Temperature Sensor
40 . . . Controller
72 . . . Power Generator Exhaust Temperature Sensor
32 . . . First Damper
43 . . . Second Damper

1. A gas turbine intake anti-icing device used for a gas turbine electric power generation system (1) having a gas turbine (2) and a power generator (20) that is coupled to the gas turbine (2) and rotationally driven to generate electrical power, the gas turbine intake anti-icing device comprising:
a power generator cooling mechanism (21, 22, 23, 25) that takes in air from the outside and introduces the air into the power generator (20) to cool the power generator (20); and
an exhaust air supply path (31, 61) that connects an intake path (9) of the gas turbine (2) to an exhaust path (30) for air that is discharged from the power generator cooling mechanism (21, 22, 23, 25) after the power generator (20) is cooled;
wherein the air discharged from the power generator cooling mechanism (21, 22, 23, 25) is supplied to the intake path (9) of the gas turbine (2) through the exhaust air supply path (31, 61).

2. The gas turbine intake anti-icing device according to claim 1, wherein the exhaust air supply path (31) is connected to the intake path (9) nearest the inlet (7) of the gas turbine (2).

3. The gas turbine intake anti-icing device according to claim 1, wherein the gas turbine (2) includes an intake air filter (50), which is disposed in the intake path (9) to purify intake air; and wherein the exhaust air supply path (61) is connected to an upstream end of the intake air filter (50).

4. The gas turbine intake anti-icing device according to claim 1, further comprising:
flow regulating mechanisms (32, 33, 63) that are disposed in the exhaust path (30) and in the exhaust air supply path (31, 61) to adjust the flow rate of air supplied from the power generator cooling mechanism (21, 22, 23, 25) to the gas turbine (2).

5. The gas turbine intake anti-icing device according to claim 4, wherein the flow regulating mechanisms include a first damper (32) and a second damper (33, 63), the first damper (32) being disposed in the exhaust path (30) to open and close the exhaust path (30), the second damper (33, 63) being disposed in the exhaust air supply path (31, 61) to open and close the exhaust air supply path (31, 61).

6. The gas turbine intake anti-icing device according to claim 1, wherein the power generator cooling mechanism (21, 22, 23, 25) includes a cooling fan (25), which introduces air into the power generator (20) and discharges the air into the exhaust path (30).

7. The gas turbine intake anti-icing device according to claim 6, wherein the cooling fan (25) is mounted on a rotor (24) of the power generator (20) and rotationally driven by the torque of the rotor (24).

8. The gas turbine intake anti-icing device according to claim 4, further comprising:
a gas turbine intake air temperature sensor (41) that is disposed in the intake path (9) nearest the gas turbine (2) to detect the intake air temperature (TI) of the gas turbine (2); and
a controller (40) that controls the operations of the flow regulating mechanisms (32, 33, 63) in accordance with the intake air temperature (TI) detected by the gas turbine intake air temperature sensor (41);
wherein, when the intake air temperature (TI) is not higher than a preselected temperature (TS), the controller (40) operates the flow regulating mechanisms (32, 33, 63) so that the air discharged from the power generator cooling mechanism (21, 22, 23, 25) is supplied to the intake path (9) of the gas turbine (2) through the exhaust air supply path (31, 61).

9. The gas turbine intake anti-icing device according to claim 8, further comprising:
a power generator exhaust air temperature sensor (42, 72) that is disposed in the exhaust air supply path (31, 61) to detect the exhaust temperature (TE) of the air discharged from the power generator cooling mechanism (21, 22, 23, 25);
wherein, when the exhaust air temperature (TE) is higher than the intake air temperature (TI), the controller (40) operates the flow regulating mechanisms (32, 33, 63) so that the air discharged from the power generator cooling mechanism (21, 22, 23, 25) is supplied to the intake path (9) of the gas turbine (2) through the exhaust air supply path (31, 61).

10. The gas turbine intake anti-icing device according to claim 2, further comprising:
flow regulating mechanisms (32, 33, 63) that are disposed in the exhaust path (30) and in the exhaust air supply path (31, 61) to adjust the flow rate of air supplied from the power generator cooling mechanism (21, 22, 23, 25) to the gas turbine (2).

11. The gas turbine intake anti-icing device according to claim 3, further comprising:
flow regulating mechanisms (32, 33, 63) that are disposed in the exhaust path (30) and in the exhaust air supply path (31, 61) to adjust the flow rate of air supplied from the power generator cooling mechanism (21, 22, 23, 25) to the gas turbine (2).

12. The gas turbine intake anti-icing device according to claim 2, wherein the power generator cooling mechanism (21, 22, 23, 25) includes a cooling fan (25), which introduces air into the power generator (20) and discharges the air into the exhaust path (30).

13. The gas turbine intake anti-icing device according to claim 3, wherein the power generator cooling mechanism (21, 22, 23, 25) includes a cooling fan (25), which introduces air into the power generator (20) and discharges the air into the exhaust path (30).

14. The gas turbine intake anti-icing device according to claim 4, wherein the power generator cooling mechanism (21, 22, 23, 25) includes a cooling fan (25), which introduces air into the power generator (20) and discharges the air into the exhaust path (30).

15. The gas turbine intake anti-icing device according to claim 5, wherein the power generator cooling mechanism (21, 22, 23, 25) includes a cooling fan (25), which introduces air into the power generator (20) and discharges the air into the exhaust path (30).

16. The gas turbine intake anti-icing device according to claim 5, further comprising:
a gas turbine intake air temperature sensor (41) that is disposed in the intake path (9) nearest the gas turbine (2) to detect the intake air temperature (TI) of the gas turbine (2); and
a controller (40) that controls the operations of the flow regulating mechanisms (32, 33, 63) in accordance with the intake air temperature (TI) detected by the gas turbine intake air temperature sensor (41);
wherein, when the intake air temperature (TI) is not higher than a preselected temperature (TS), the controller (40) operates the flow regulating mechanisms (32, 33, 63) so that the air discharged from the power generator cooling mechanism (21, 22, 23, 25) is supplied to the intake path (9) of the gas turbine (2) through the exhaust air supply path (31, 61).

17. The gas turbine intake anti-icing device according to claim 6, further comprising:
a gas turbine intake air temperature sensor (41) that is disposed in the intake path (9) nearest the gas turbine (2) to detect the intake air temperature (TI) of the gas turbine (2); and
a controller (40) that controls the operations of the flow regulating mechanisms (32, 33, 63) in accordance with the intake air temperature (TI) detected by the gas turbine intake air temperature sensor (41);
wherein, when the intake air temperature (TI) is not higher than a preselected temperature (TS), the controller (40) operates the flow regulating mechanisms (32, 33, 63) so that the air discharged from the power generator cooling mechanism (21, 22, 23, 25) is supplied to the intake path (9) of the gas turbine (2) through the exhaust air supply path (31, 61).

18. The gas turbine intake anti-icing device according to claim 7, further comprising:
a gas turbine intake air temperature sensor (41) that is disposed in the intake path (9) nearest the gas turbine (2) to detect the intake air temperature (TI) of the gas turbine (2); and
a controller (40) that controls the operations of the flow regulating mechanisms (32, 33, 63) in accordance with the intake air temperature (TI) detected by the gas turbine intake air temperature sensor (41);
wherein, when the intake air temperature (TI) is not higher than a preselected temperature (TS), the controller (40) operates the flow regulating mechanisms (32, 33, 63) so that the air discharged from the power generator cooling mechanism (21, 22, 23, 25) is supplied to the intake path (9) of the gas turbine (2) through the exhaust air supply path (31, 61).
